(19) United States
(12) Patent Application Publication
(10) Pub. No.: US 2014/0177591 A1
(43) Pub. Date: Jun. 26, 2014

(54) SYSTEMS AND METHODS FOR REDUCED LATENCY CIRCUIT SWITCHED FALLBACK

(71) Applicant: QUALCOMM Incorporated, San Diego, CA (US)

(72) Inventors: Mungal Singh DHANDA, Slough (GB); Divaydeep SIKRI, Farnborough (GB); Damon Mark BEALES, Reading (GB); Gareth D. JOHN, Southampton (GB); Krishna Rao MANDADAPU, San Diego, CA (US)

(73) Assignee: QUALCOMM Incorporated, San Diego, CA (US)

(21) Appl. No.: 14/018,175

(22) Filed: Sep. 4, 2013

Related U.S. Application Data
(60) Provisional application No. 61/745,263, filed on Dec. 21, 2012.

(51) Int. Cl. H04W 36/16

(52) U.S. Cl. CPC H04W 36/165
USPC 370/331

(57) ABSTRACT

Systems, methods, and devices for wireless communication by a wireless communication device are described. A circuit switched fallback from an LTE cell to a GERAN cell is initiated. A system information type 3 message is received. The GERAN cell is accessed based on the system information type 3 message without receiving a system information type 13 message. A circuit switched connection is established on the GERAN cell. Other aspects, embodiments, and features are also claimed and described.

### RELATED APPLICATIONS AND PRIORITY CLAIM

This application is related to and claims priority from U.S. Provisional Patent Application Ser. No. 61/745,263, filed Dec. 21, 2012, for “ENHANCED MAXIMUM POWER METHODS AND SYSTEMS FOR MULTICARRIER IMBALANCE,” which is incorporated herein by reference.

### TECHNICAL FIELD

The technology discussed below relates to communication systems, and more specifically, to systems and methods for reduced latency circuit switched fallback. Aspect of the technology discussed below enable and provide improved call set up times as well as battery savings.

### BACKGROUND

Wireless communication systems have become an important means by which many people worldwide have come to communicate. A wireless communication system may provide communication for a number of wireless communication devices, each of which may be serviced by a base station.

New wireless communication devices are continuously being released to the public. These new wireless communication devices boast more features and increased reliability. These wireless communication devices may be capable of performing voice and data operations.

One major concern for users of wireless communication devices is the time it takes to set up a voice call. A long delay in establishing a voice call reduces the satisfaction rate of wireless communication providers. Benefits may be realized by reducing the delay of voice call setup.

### SUMMARY OF SOME EXAMPLE EMBODIMENTS

Embodiments of the present invention address the above issues as well as others. Embodiments of the present invention provide power efficient devices, systems, and methods that can alleviate time delays. Doing so can not only utilize power resources efficiently but can aid in minimizing delays associated with network communications.

A method for wireless communication by a wireless communication device is described. A circuit switched fallback from a long term evolution (LTE) cell to a GERAN cell is initiated. A system information type 3 message is received. The GERAN cell is accessed based on the system information type 3 message without receiving a system information type 13 message. A circuit switched connection on the GERAN cell is established.

A general packet radio service suspension request may be sent if the wireless communication device does not support a dual transfer mode and the system information type 3 message indicates that the GERAN cell supports general packet radio service. A general packet radio service suspension request may not be sent if the system information type 3 message indicates that the GERAN cell does not support general packet radio service.

A system information type 6 message may be received. A general packet radio service suspension request may be sent if the system information type 6 message indicates that the GERAN cell does not support a dual transfer mode. A packet switched connection may be established if the system information type 6 message indicates that the GERAN cell supports a dual transfer mode.

A system information type 13 message may be received after releasing the circuit switched connection. General packet radio service procedures may be performed based on the system information type 13 message.

Accessing the GERAN cell may include sending a random access channel message. Establishing the circuit switched connection may include performing a location area update without performing a routing area update. The method may also include switching from an idle mode to a dedicated mode without receiving a system information type 13 message.

An apparatus for wireless communication is also described. The apparatus includes a processor, memory in electronic communication with the processor and instructions stored in the memory. The instructions are executable to initiate a circuit switched fallback from an LTE cell to a GERAN cell. The instructions are also executable to receive a system information type 3 message. The instructions are further executable to access the GERAN cell based on the system information type 3 message without receiving a system information type 13 message. The instructions are additionally executable to establish a circuit switched connection on the GERAN cell.

A wireless device is also described. The wireless device includes means for initiating a circuit switched fallback from an LTE cell to a GERAN cell. The wireless device also includes means for receiving a system information type 3 message. The wireless device further includes means for accessing the GERAN cell based on the system information type 3 message without receiving a system information type 13 message. The wireless device additionally includes means for establishing a circuit switched connection on the GERAN cell.

A computer-program product for wireless communications is also described. The computer-program product includes a non-transitory computer-readable medium having instructions thereon. The instructions include code for causing a wireless communication device to initiate a circuit switched fallback from an LTE cell to a GERAN cell. The instructions also include code for causing the wireless communication device to receive a system information type 3 message. The instructions further include code for causing the wireless communication device to access the GERAN cell based on the system information type 3 message without receiving a system information type 13 message. The instructions additionally include code for causing the wireless communication device to establish a circuit switched connection on the GERAN cell.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments, it should be understood that such exemplary embodiments can be implemented in various devices, systems, and methods.

### BRIEF DESCRIPTION OF THE DRAWINGS

FIG. 1 is a block diagram illustrating a wireless communication system with a wireless communication device, a long term evolution (LTE) base station and a GERAN base station according to some embodiments of the present invention;

FIG. 2 is a block diagram illustrating a network operating according to some embodiments of the present invention;

FIG. 3 is a thread diagram illustrating a circuit switched fallback (CSFB) procedure according to current specifications;

FIG. 4 is a flow diagram of a method for performing a reduced latency circuit switched fallback (CSFB) procedure according to some embodiments;

FIG. 5 is a thread diagram illustrating a reduced latency circuit switched fallback (CSFB) procedure according to some embodiments;

FIG. 6 is a flow diagram of a detailed method for performing a reduced latency circuit switched fallback (CSFB) procedure according to some embodiments;

FIG. 7 is a thread diagram illustrating a reduced latency circuit switched fallback (CSFB) procedure according to some embodiments;

FIG. 8 illustrates certain components that may be included within a base station according to some embodiments; and

FIG. 9 illustrates certain components that may be included within a wireless communication device according to some embodiments.

### DETAILED DESCRIPTION

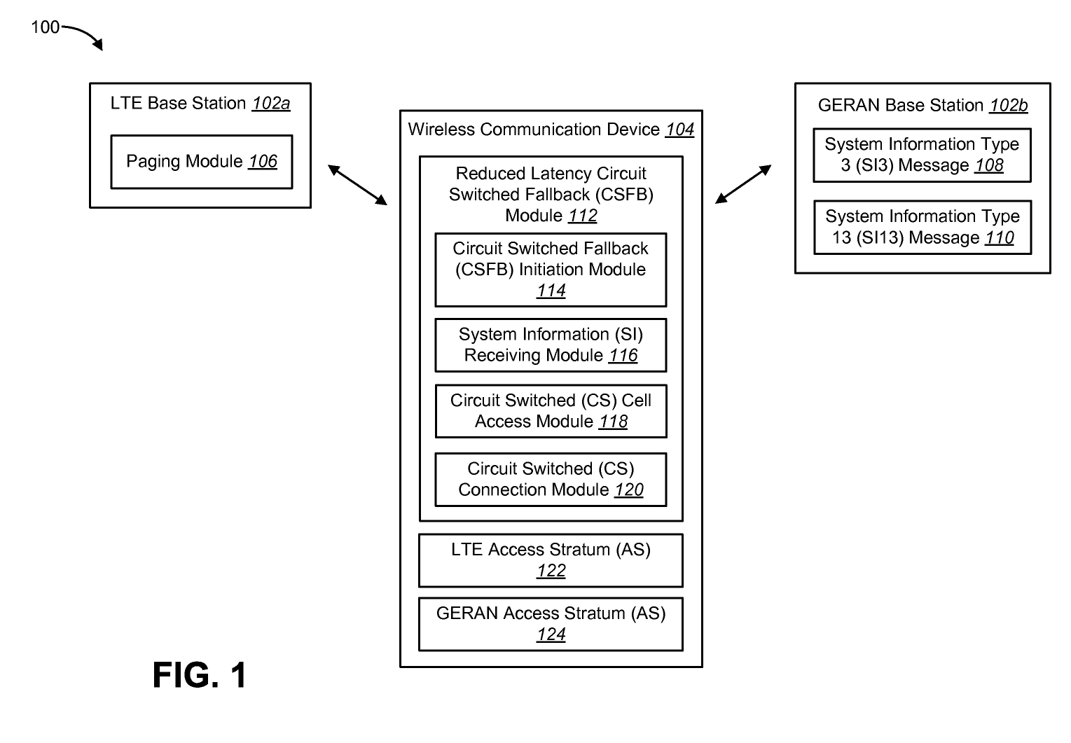

FIG. 1 is a block diagram illustrating a wireless communication system 100 with a wireless communication device 104, an LTE base station 102a, and a GERAN base station 102b according to some embodiments of the present invention. Wireless communication systems 100 are widely deployed to provide various types of communication content such as voice, data, and so on. A reduced latency circuit switched fallback may be performed on the wireless communication system 100 according to the systems and methods described herein.

A base station 102 is a station that may communicate with one or more wireless communication devices 104. A base station 102 may also be referred to as, and may include some or all of the functionality of an access point, a broadcast transmitter, a NodeB, an evolved NodeB, a base transceiver station, etc. The term “base station” will be used herein. Each base station 102 may provide communication coverage for a particular geographic area. A base station 102 may provide communication coverage for one or more wireless communication devices 104. The term “cell” can refer to a base station 102 and/or its coverage area depending on the context in which the term is used.

Communications in a wireless system (e.g., a multiple-access system) may be achieved through transmissions over a wireless link. Such a wireless link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. SISO and MISO systems are particular instances of a MIMO system. The MIMO system can provide improved performance (e.g., higher throughput, greater capacity or improved reliability) if the additional dimensionalities created by the multiple transmit and receive antennas are utilized.

The wireless communication system 100 may utilize MIMO. A MIMO system may support both time division duplex (TDD) and frequency division duplex (FDD) systems. In a TDD system, uplink and downlink transmissions are on the same frequency region so that the reciprocity principle allows the estimation of the downlink channel from the uplink channel. This enables a transmitting wireless device (e.g., base station 102 or wireless communication device 104) to extract transmit beamforming gain from communications received by the transmitting wireless device.

The wireless communication system 100 may be a multiple-access system capable of supporting communication with multiple wireless communication devices 104 by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, evolution-data optimized (EV-DO), single-carrier frequency division multiple access (SC-FDMA) systems, 3^{rd} Generation Partnership Project (3GPP) Long Term Evolution (LTE) systems, and spatial division multiple access (SDMA) systems.

The terms “networks” and “systems” are often used interchangeably. A CDMA network may implement a radio technology such as Universal Terrestrial Radio Access (UTRA), cdma2000, etc. UTRA includes W-CDMA and Low Chip Rate (LCR) while cdma2000 covers IS-2000, IS-95, and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3rd Generation Partnership Project” (3GPP). cdma2000 is described in documents from an organization named “3rd Generation Partnership Project 2” (3 GPP2).

The 3^{rd} Generation Partnership Project (3GPP) is a collaboration between groups of telecommunications associations that aims to define a globally applicable 3^{rd} generation (3G) mobile phone specification. 3GPP Long Term Evolution (LTE) is a 3GPP project aimed at improving the Universal Mobile Telecommunications System (UMTS) mobile phone standard. The 3GPP may define specifications for the next generation of mobile networks, mobile systems, and mobile devices.

In 3GPP Long Term Evolution (LTE), a wireless communication device 104 may be referred to as a “user equipment” (UE). In 3GPP Global System for Mobile Communications (GSM), a wireless communication device 104 may be referred to as a “mobile station” (MS). A wireless communication device 104 may also be referred to as, and may include some or all of the functionality of, a terminal, an access terminal, a subscriber unit, a station, etc. A wireless communication device 104 may be a cellular phone, a personal digital assistant (PDA), a wireless device, a wireless modem, a handheld device, a laptop computer, a Session Initiation Protocol (SIP) phone, a wireless local loop (WLL) station, a television, an entertainment device, a phone, a smartphone, a computing device, a tablet computer, many devices capable of processing and wireless communication, etc.

A wireless communication device 104 may communicate with zero, one or multiple base stations 102 on the downlink and/or uplink at any given moment. The downlink (or forward link) refers to the communication link from a base station 102 to a wireless communication device 104, and the uplink (or reverse link) refers to the communication link from a wireless communication device 104 to a base station 102.

While a wireless communication device 104 is being served by (e.g., camped on) an LTE base station 102a, the wireless communication device 104 may be informed of an incoming circuit switched (CS) voice call. The term “camp” refers to a process in which the wireless communication device 104 monitors a cell for system information and paging information. The cell on which the wireless communication device 104 is camped is referred to as the serving cell.

Because LTE does not currently support circuit switched (CS) voice calls, networks may use legacy systems (e.g., GERAN, UTRAN, or CDMA2000 1xRTT) to carry the circuit switched (CS) voice calls. When a wireless communication device 104 is operating in an LTE mode (e.g., data transfer, browsing, uploading data, etc.), current standards provide that the wireless communication device 104 may receive an indication (e.g., a paging message) of the circuit switched (CS) voice call through LTE. The wireless communication device 104 may then perform a circuit switched fallback (CSFB) to a legacy system where a circuit switched (CS) connection may be established to enable the voice call. For example, during a circuit switched fallback (CSFB), the wireless communication device 104 may switch from the LTE base station 102a to the GERAN base station 102b to establish a circuit switched (CS) connection to set up the circuit switched (CS) voice call.

One problem with the conventional circuit switched fallback (CSFB) procedure is the time that it takes to set up the circuit switched (CS) voice call. There may be considerable delay from the moment the wireless communication device 104 receives an indication of a mobile terminated circuit switched (CS) voice call in the network until the wireless communication device 104 establishes a circuit switched (CS) connection on a GERAN cell. Current specifications require the wireless communication device 104 to read certain system information (SI) messages before the wireless communication device 104 may access the GERAN cell. These system information (SI) messages include a system information type 3 (SI3) message 108, a system information type 13 (SI13) message 110, as well as other system information (SI) messages (e.g., a system information type 1 (SI1) message). It can take several seconds for the wireless communication device 104 to read all the system information (SI) and then access the GERAN cell.

One particular problem associated with the circuit switched fallback (CSFB) procedure is reading the system information type 13 (SI13) message 110, which may be broadcast at a low rate. According to current specifications, the wireless communication device 104 cannot access the GERAN cell until the wireless communication device 104 receives the system information type 13 (SI13) message 110 from the GERAN base station 102b. However, the system information type 13 (SI13) message 110 is sent at most once every 1.882 seconds, but the system information type 13 (SI13) message 110 can be sent as slow as once every 7.53 sec. Therefore, the circuit switched (CS) voice call setup on the GERAN cell can be delayed by as much as 7.53 seconds.

The system information type 13 (SI13) message 110 also indicates what kind of network mode of operation (NMO) the network supports. The network mode of operation (NMO) may be mode 1, 2, or 3. Depending on the network mode of operation (NMO), during a circuit switched fallback (CSFB) the wireless communication device 104 may perform separate or combined registrations for circuit switched (CS) operations and packet switched (PS) operations.

If the network mode of operation (NMO) is 2 or 3, the wireless communication device 104 may perform separate registrations for circuit switched (CS) operations (e.g., the voice call) and packet switched (PS) operations (e.g., data transmission). In other words, the wireless communication device 104 will have to do an individual attach or registration update for each domain (e.g., circuit switched (CS) domain and packet switched (PS) domain) independently. Therefore, if the network mode of operation (NMO) is 2 or 3, the wireless communication device 104 may establish a circuit switched (CS) connection for the voice call upon performing a location area update (if needed) on the GERAN cell. In order for the wireless communication device 104 to establish a circuit switched (CS) connection for the voice call, the wireless communication device 104 may perform a location area update to enable the network to start a voice call on the wireless communication device 104.

On the other hand, if the network mode of operation (NMO) is 1, the wireless communication device 104 may perform a combined routing area update (RAU) for both the circuit switched (CS) and packet switched (PS) domain before setting up the voice call. Therefore, establishing the packet switched (PS) connection when the network mode of operation (NMO) is 1 introduces further delay in the voice call setup in addition to the delay associated with waiting for the system information type 13 (SI13) message 110. Some systems may provide the wireless communication device 104 an option to perform a separate location area update instead of a combined routing area update procedure upon circuit switched fallback (CSFB) even if the network mode of operation (NMO) is 1. However, according to the systems and methods described herein, the wireless communication device 104 may perform a location area update (instead of a combined routing area update procedure) regardless of the network mode of operation (NMO).

A primary reason that the current specifications require the system information type 13 (SI13) message 110 to be read by the wireless communication device 104 is to enable the wireless communication device 104 to determine if the network supports dual transfer mode (DTM). In one configuration, dual transfer mode (DTM) may synchronize the circuit switched (CS) and packet switched (PS) services of a GSM and a general packet radio service (GPRS) network. Therefore, dual transfer mode (DTM) may enable the wireless communication device 104 to use GSM (e.g., circuit switched (CS) domain) and general packet radio service (GPRS) (e.g., packet switched (PS) domain) functionality simultaneously with a single transceiver. The system information type 13 (SI13) message 110 indicates whether the network supports dual transfer mode (DTM).

In some scenarios, if the wireless communication device 104 supports dual transfer mode (DTM), then upon receiving the system information type 13 (SI13) message 110, the wireless communication device 104 may then perform both voice and data operations. But if the network does not support dual transfer mode (DTM), the wireless communication device 104 may establish a circuit switched (CS) connection just for the voice call, regardless of whether the wireless communication device 104 supports dual transfer mode (DTM). It should be noted that the wireless communication device 104 may perform a location area update regardless of whether dual transfer mode (DTM) is supported.

However, the wireless communication device 104 does not need to wait for the system information type 13 (SI13) message 110 to establish a circuit switched (CS) voice call. Regardless of the network mode of operation (NMO), the wireless communication device 104 may receive a system information type 3 (SI3) message 108, perform a location area update (if required), and then continue with voice call setup without acquiring a system information type 13 (SI13) message 110. In other words, the wireless communication device 104 may access the GERAN cell without receiving (or reading) the system information type 13 (SI13) message 110.

It should also be noted that some systems may provide minimal information to establish a connection on a GERAN cell. For example, some systems provide a system information type 3 (SI3) message 108 and may provide a system information type 13 (SI13) message 110 without providing other system information. However, according to some systems and methods described herein, the wireless communication device 104 may intentionally skip receiving a system information type 13 (SI13) message 110. In other words, the wireless communication device 104 may not attempt to acquire a system information type 13 (SI13) message 110 when starting to establish a GERAN connection.

Therefore, when switching from an LTE cell to a GERAN cell during circuit switched fallback (CSFB), the wireless communication device 104 may establish a circuit switched (CS) connection without receiving the system information type 13 (SI13) message 110. Instead, the wireless communication device 104 may perform a circuit switched fallback (CSFB) for the circuit switched (CS) voice call based on the system information type 3 (SI3) message 108 and an optional system information type 1 (SI1) message, which are broadcast (by the GERAN base station 102b) as slow as once every 1.88 seconds. Therefore, the latency of the circuit switched fallback (CSFB) may be reduced from a maximum of 7.5 seconds to a maximum of 1.88 seconds if the wireless communication device 104 skips the system information type 13 (SI13) message 110 when establishing the circuit switched (CS) connection.

In one embodiment of the present invention, the wireless communication device 104 may include a reduced latency circuit switched fallback (CSFB) module 112. The wireless communication device 104 may be camped on an LTE cell associated with the LTE base station 102a. The wireless communication device 104 may communicate with the LTE base station 102a via an LTE access stratum module 122.

In response to a voice call notification, a paging module 106 of the LTE base station 102a may send a paging message to the wireless communication device 104. Upon receiving the paging message, a circuit switched fallback (CSFB) initiation module 114 may initiate a circuit switched fallback (CSFB) from the LTE cell to a GERAN cell associated with the GERAN base station 102b. The wireless communication device 104 may communicate with one or more GERAN base stations 102b via a GERAN access stratum (AS) module 124. In one embodiment, the circuit switched fallback (CSFB) initiation module 114 may determine the best GERAN cell to camp on from multiple GERAN cells.

A system information (SI) receiving module 116 may receive a system information type 3 (SI3) message 108 from the GERAN base station 102b. The system information (SI) receiving module 116 may also receive an optional system information type 1 (SI1) message from the GERAN base station 102b.

A circuit switched (CS) cell access module 118 may access the GERAN cell based on the system information type 3 (SI3) message 108 without receiving a system information type 13 (SI13) message 110. In one embodiment, the circuit switched (CS) cell access module 118 may send a random access channel (RACH) message to the GERAN base station 102b to access the GERAN cell. A circuit switched (CS) connection module 120 may establish a circuit switched (CS) connection of the GERAN cell. This may include performing a location area update. Upon establishing the circuit switched (CS) connection, the voice call may be set up.

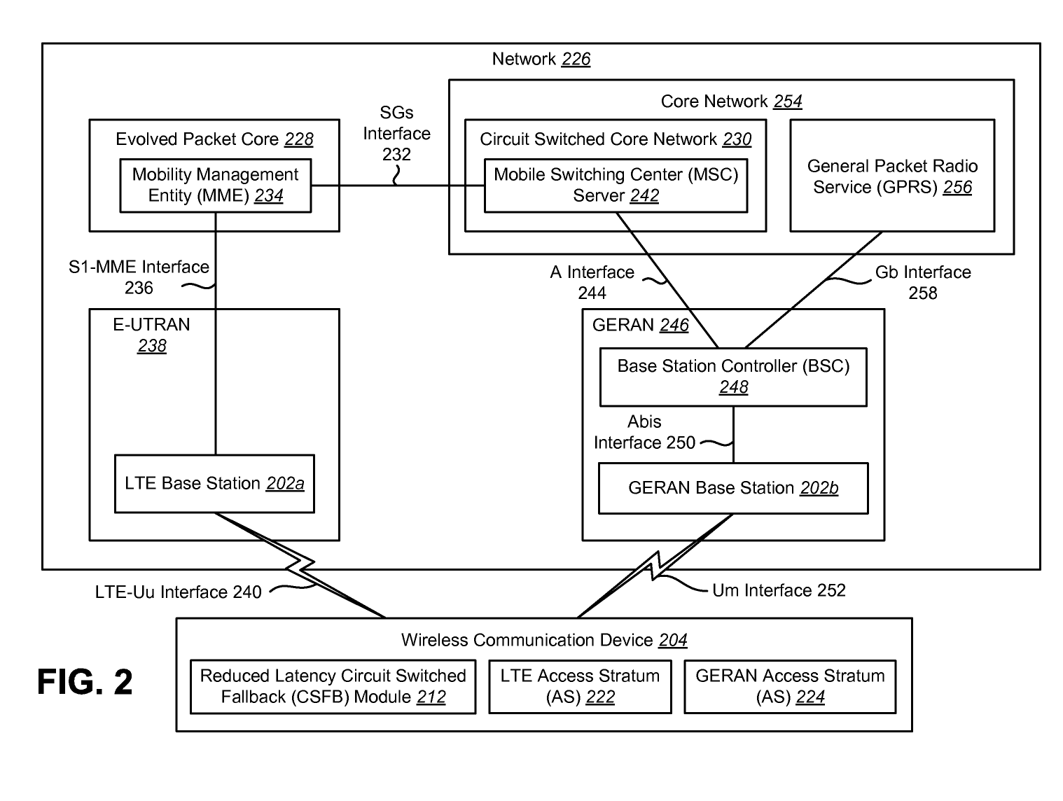

FIG. 2 is a block diagram illustrating a network 226 operating according to some embodiments of the present invention. The network 226 may be used to perform a reduced latency circuit switched fallback (CSFB) from an LTE cell to a GERAN cell for voice calls as illustrated in connection with FIG. 1. LTE is optimized for packet switched (PS) services, but may handle circuit switched (CS) services (e.g., circuit switched (CS) voice calls) through circuit switched fallback (CSFB) to a Global System for Mobile Communications (GSM) system. Circuit switched fallback (CSFB) enables the provisioning of voice calls in a circuit switched (CS) domain. To provide for voice calls, LTE may reuse circuit switched (CS) infrastructure (e.g., GSM) when the wireless communication device 204 is served by an E-UTRAN 238.

In one embodiment, the network 226 may include an evolved UMTS radio access network (E-UTRAN) 238, which may operate according to LTE standards. The E-UTRAN 238 may include one or more LTE base stations 202a (e.g., eNode Bs) that may be connected to an evolved packet core (EPC) 228 through a mobility management entity (MME) 234. The LTE base stations 202a may be connected to the mobility management entity (MME) 234 by an S1-MME interface 236, which provides for signaling and data to be transferred between the mobility management entity (MME) 234 and the LTE base stations 202a. The LTE base stations 202a may interface with an LTE access stratum module 222 of the wireless communication device 204 using an LTE-Uu Interface 240. The E-UTRAN 238 provides an air interface access method for the wireless communication device 204. In one configuration, the wireless communication device 204 may include a reduced latency circuit switched fallback (CSFB) module 212. Connectivity is provided between the wireless communication device 204 and the EPC 228 by the E-UTRAN 238. The E-UTRAN 238 may transport data packets between multiple wireless communication devices 204.

The network 226 may also include a GSM EDGE Radio Access Network (GERAN) 246, which may operate according to Global System for Mobile Communications (GSM) standards. The GERAN 246 may include one or more GERAN base stations 202b and the control equipment for the GERAN base stations 202b (e.g., one or more base station controllers (BSCs) 248). The GERAN 246 provides an air interface access method for the wireless communication device 204. Connectivity is provided between the wireless communication device 204 and a core network 254 by the GERAN 246. The core network 254 may include a circuit switched (CS) core network 230 and a general packet radio service (GPRS) 256. The circuit switched (CS) core network 230 may provide circuit switched (CS) services (e.g., voice calls), while the general packet radio service (GPRS) 256 may provide packet switched (PS) services (e.g., data).

The GERAN 246 is connected internally or externally to other functional entities by various interfaces (e.g., an A interface 244, an Abis interface 250, a Gb interface 258 and a Um interface 252). The GERAN 246 is attached to a mobile switching center (MSC) 242 in the circuit switched (CS) core network 230 via an A interface 244. The GERAN 246 is attached to the general packet radio service (GPRS) 256 via a Gb interface 258. The base station controllers (BSCs) 248 support these interfaces. In addition, the base station controllers (BSCs) 248 manage a set of GERAN base stations 202b through Abis interfaces 250. The Um interface 252 connects a GERAN base station 202b with the wireless communication device 204. In one embodiment, the wireless communication device 204 may communicate with one or more GERAN base stations 202b via a GERAN access stratum (AS) module 224.

The E-UTRAN 238 may interface with the GERAN 246 via an SGs interface 232. In one embodiment, the SGs interface 232 connects the mobility management entity (MME) 234 (of the EPC 228) to the mobile switching center (MSC) 242 (of the circuit switched (CS) core network 230). The MSC 242 may use the SGs interface 232 to forward circuit switched (CS) core network 230 domain paging messages to the wireless communication device 204 that is camped on an LTE cell. For example, for an incoming call, a paging request message may be sent from the mobile switching center (MSC) 242 to the mobility management entity (MME) 234, which may forward the paging message to the LTE base stations 202a.

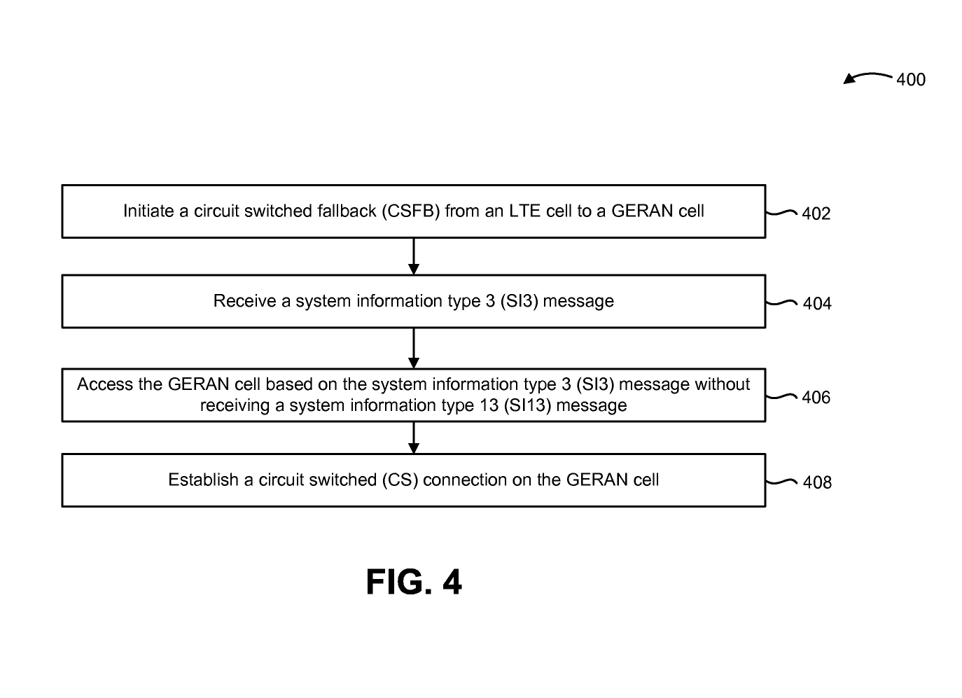

The LTE base stations 202a may then send the paging message (in the form of a radio resource control (RRC) message, for instance) to the wireless communication device 204 to inform the wireless communication device 204 about the incoming voice call. The paging message may inform the wireless communication device 204 that the incoming voice call originates from the circuit switched (CS) core network 230 domain. The wireless communication device 204 may then initiate a reduced latency circuit switched fallback (CSFB) procedure to switch from the LTE cell to a GERAN cell to establish a circuit switched (CS) connection for the voice call, as described in more detail in connection with FIG. 4.

The network 226 may be further connected to additional networks outside the network 226, such as a corporate intranet, the Internet, or a conventional public switched telephone network (not shown). The network 226 may transport data packets between each wireless communication device 204 and such outside networks.

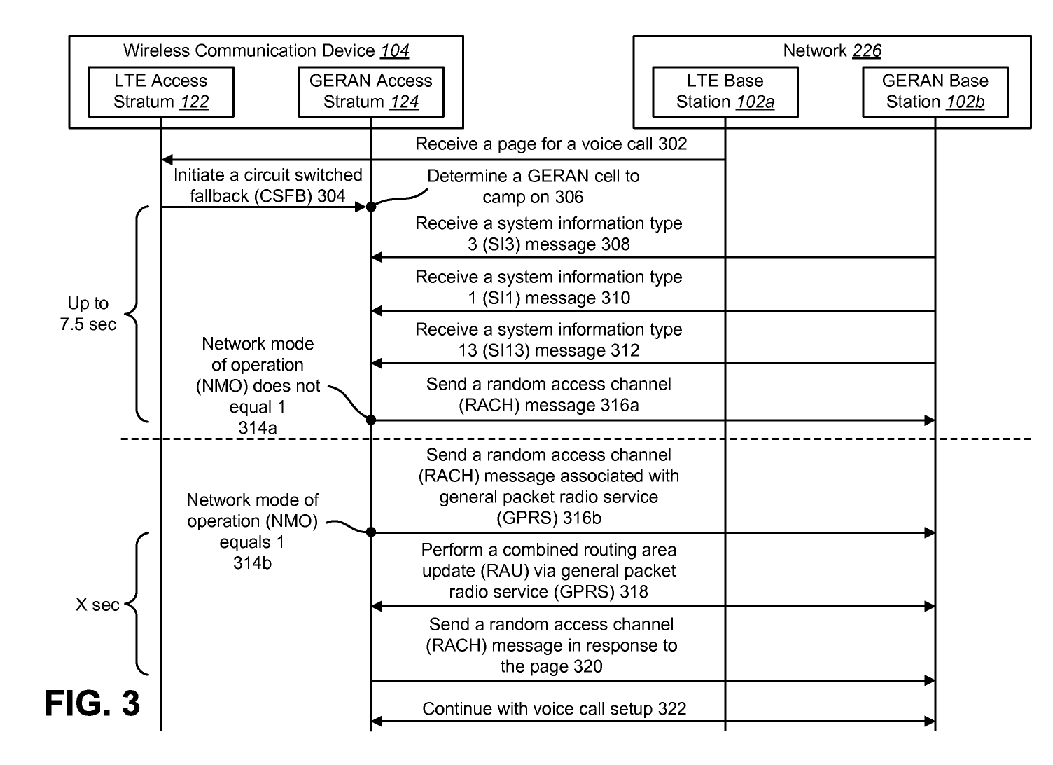

FIG. 3 is a thread diagram illustrating a circuit switched fallback (CSFB) procedure according to current specifications. The wireless communication device 104 illustrated in FIG. 3 may be similar to the wireless communication device 104 described in connection with FIG. 1. The wireless communication device 104 may communicate with an LTE base station 102a and a GERAN base station 102b that are part of a network 226.

In one implementation, the wireless communication device 104 may communicate with the LTE base station 102a via an LTE access stratum (AS) 122. The wireless communication device 104 may communicate with the GERAN base station 102b via a GERAN access stratum (AS) 124. Initially, the wireless communication device 104 may be camped on an LTE cell associated with the LTE base station 102a. The LTE access stratum (AS) 122 may be in an idle state and the GERAN access stratum (AS) 124 may be in a NULL state.

The wireless communication device 104 may receive 302 a page for a voice call from the LTE base station 102a. Because the wireless communication device 104 is camped on an LTE cell, the wireless communication device 104 may initiate 304 a circuit switched fallback (CSFB) to a GERAN cell. The wireless communication device 104 may determine 306 the best GERAN cell to camp on. For example, the wireless communication device 104 may obtain signal measurements for each GERAN cell detected by the wireless communication device 104. The wireless communication device 104 may compute a cell ranking criterion for each GERAN cell based on the signal measurements and one or more cell reselection parameters for that GERAN cell.

Upon determining 306 a GERAN cell to camp on, the wireless communication device 104 may receive system information (SI) broadcast from the GERAN base station 102b associated with that cell. The wireless communication device 104 may receive 308 a system information type 3 (SI3) message 108 and may receive 310 a system information type 1 (SI1) message. Furthermore, according to current specifications, the wireless communication device 104 must wait to receive 312 a system information type 13 (SI13) message 110 from the GERAN base station 102b before accessing the GERAN cell.

It should be noted that it may take up to 7.5 seconds from the time the wireless communication device 104 starts camping on the GERAN cell (step 306) until the wireless communication device 104 receives 312 the system information type 13 (SI13) message 110. During circuit switched fallback (CSFB) from the LTE cell to the GERAN cell, the wireless communication device 104 is required to read the system information type 13 (SI13) message 110 to determine if it should perform a location updating procedure or a combined routing area updating (RAU) procedure. This requirement is specified in 3GPP TS 45.008 section 6.1: “For the specific case of CS Fallback by redirection from E-UTRA, the MS may use available system information to camp on a suitable cell only and, if the LAI of the new cell is different to the one stored in the MS, the MS shall initiate a location updating or a combined routing area updating procedure as specified in 3GPP TS 24.008.”

Upon receiving 312 the system information type 13 (SI13) message 110, the wireless communication device 104 may determine 314 whether the network mode of operation (NMO) is 1. If the wireless communication device 104 determines 314a that the network mode of operation (NMO) does not equal 1 (e.g., the network mode of operation (NMO) is 2 or 3), then the wireless communication device 104 may send 316a a random access channel (RACH) message to the GERAN base station 102b to access the GERAN cell.

However, if the wireless communication device 104 determines 314b that the network mode of operation (NMO) is 1, then the wireless communication device 104 may perform a combined registration for the circuit switched (CS) domain and the packet switched (PS) domain. The wireless communication device 104 may send 316b a random access channel (RACH) message associated with general packet radio service (GPRS). The wireless communication device 104 and the GERAN base station 102b may then perform 318 a combined routing area update (RAU) via general packet radio service (GPRS) channels to establish a packet switched (PS) connection. The wireless communication device 104 may then send 320 a random access channel (RACH) message in response to the page to access the GERAN cell. It should be noted that establishing the packet switched (PS) connection (e.g., performing the combined RAU) may require X seconds in addition to the time (e.g., up to 7.5 seconds) from when the wireless communication device 104 starts camping on the GERAN cell (step 306) until the wireless communication device 104 finally receives the system information type 13 (SI13) message 110.

Upon accessing the GERAN cell, the wireless communication device 104 may continue 322 with the voice call setup. This may include establishing a circuit switched (CS) connection between the wireless communication device 104 and the GERAN cell. For example, the wireless communication device 104 may establish a radio resource (RR) connection for the voice call. Therefore, according to current specifications, when the wireless communication device 104 begins camping on the GERAN cell, the maximum time before the wireless communication device 104 may establish a circuit switched (CS) connection is 7.5 seconds plus X seconds (if the network mode of operation (NMO) is 1).

FIG. 4 is a flow diagram of a method 400 for performing a reduced latency circuit switched fallback (CSFB) procedure according to some embodiments. The method 400 may be performed by a wireless communication device 104. In one configuration, the wireless communication device 104 may include a reduced latency circuit switched fallback (CSFB) module 112. The wireless communication device 104 may initiate 402 a circuit switched fallback (CSFB) from an LTE cell to a GERAN cell. For example, while camped on an LTE cell associated with an LTE base station 102a, the wireless communication device 104 may receive a paging message (e.g., a page) from the LTE base station 102a indicating a circuit switched (CS) voice call for the wireless communication device 104. Upon receiving the paging message, the wireless communication device 104 may determine the best GERAN cell to camp on from multiple GERAN cells.

The wireless communication device 104 may receive 404 a system information type 3 (SI3) message 108. The wireless communication device 104 may receive 404 the system information type 3 (SI3) message 108 from a GERAN base station 102b associated with the GERAN cell that the wireless communication device 104 selects to camp on. The wireless communication device 104 may also receive an optional system information type 1 (SI1) message from the GERAN base station 102b.

The wireless communication device 104 may access 406 the GERAN cell based on the system information type 3 (SI3) message 108 without receiving a system information type 13 (SI13) message 110. In one embodiment, accessing 406 the GERAN cell may include sending a random access channel (RACH) message to the GERAN base station 102b.

The wireless communication device 104 may establish 408 a circuit switched (CS) connection on the GERAN cell. This may include performing a location area update. Upon establishing the circuit switched (CS) connection, the voice call may be set up.

In one embodiment, after release of the circuit switched (CS) connection, the wireless communication device 104 may then acquire a system information type 13 (SI13) message 110 and may follow general packet radio service (GPRS) procedures. For example, after a voice call is released, the wireless communication device 104 may perform idle mode operations. This may include refreshing the system information (SI) by receiving the system information type 13 (SI13) message 110. Based on the system information type 13 (SI13) message 110, the wireless communication device 104 may determine whether to go to sleep or perform a registration update for one or both of the circuit switched (CS) or packet switched (PS) domains.

In one embodiment, reduced latency circuit switched fallback (CSFB) may be implemented by adding the following line to 3GPP TS 45.008 section 6.1: “As an option, mobile may perform location updating only to minimize delay to CS fallback.” Therefore, the wireless communication device 104 may perform a location area update (based on a location area identity (LAI)) and not a routing area update (RAU) as currently required by the specifications. For instance, the wireless communication device 104 may perform a location area update if the location area identity (LAI) of a new cell is different to the one stored in the wireless communication device 104.

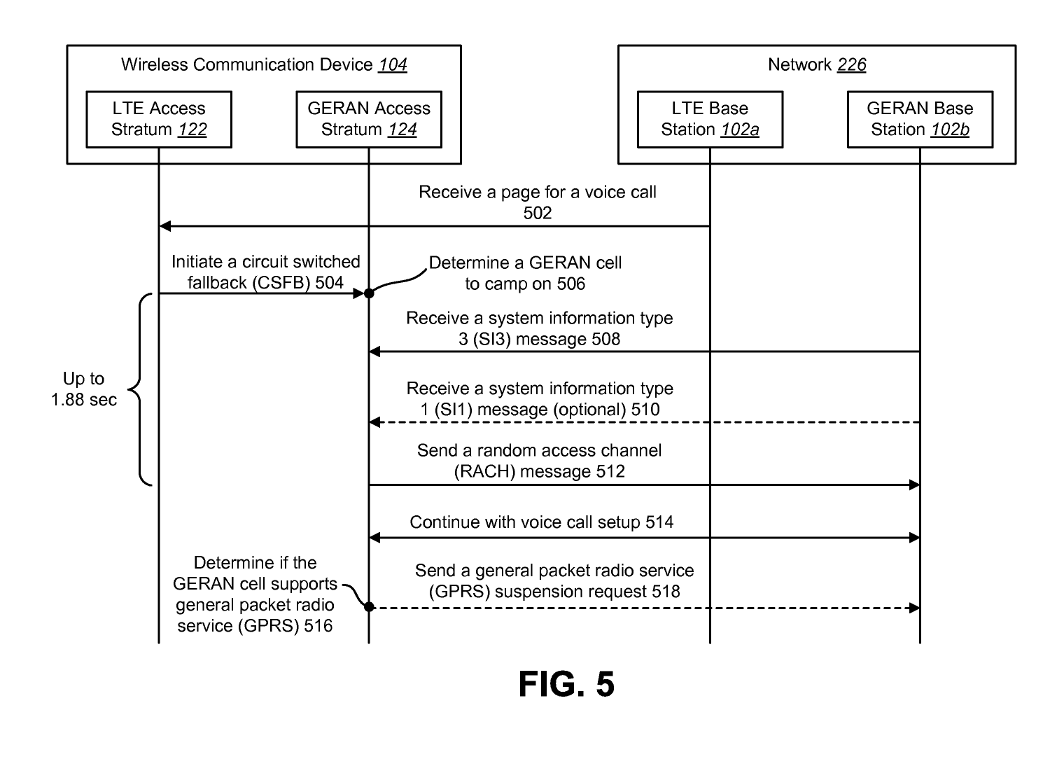

FIG. 5 is a thread diagram illustrating a reduced latency circuit switched fallback (CSFB) procedure according to some embodiments. The wireless communication device 104 illustrated in FIG. 5 may be similar to the wireless communication device 104 described in connection with FIG. 1. The wireless communication device 104 may communicate with an LTE base station 102a and a GERAN base station 102b that are part of a network 226.

In one implementation, the wireless communication device 104 may communicate with the LTE base station 102a via an LTE access stratum (AS) 122. The wireless communication device 104 may communicate with the GERAN base station 102b via a GERAN access stratum (AS) 124. Initially, the wireless communication device 104 may be camped on an LTE cell associated with the LTE base station 102a. The LTE access stratum (AS) 122 may be in an idle state and the GERAN access stratum (AS) 124 may be in a NULL state.

The wireless communication device 104 may receive 502 a page for a voice call from the LTE base station 102a. Because the wireless communication device 104 is camped on an LTE cell, the wireless communication device 104 may initiate 504 a circuit switched fallback (CSFB) to a GERAN cell. The wireless communication device 104 may determine 506 the best GERAN cell to camp on. Upon determining 506 a GERAN cell to camp on, the wireless communication device 104 may receive system information (SI) broadcast from the GERAN base station 102b associated with that cell. The wireless communication device 104 may receive 508 a system information type 3 (SI3) message 108 and may receive 510 an optional system information type 1 (SI1) message. It should be noted that the wireless communication device 104 may acquire the system information type 3 (SI3) message 108 (and the optional system information type 1 (SI1) message) within 1.88 seconds from beginning to camp on the GERAN cell (step 506).

Upon receiving 508 the system information type 3 (SI3) message 108 the wireless communication device 104 may access the GERAN cell based on the system information type 3 (SI3) message 108 without receiving a system information type 13 message 110. For example, the wireless communication device 104 may send 512 a random access channel (RACH) message to the GERAN base station 102b to access the GERAN cell.

Upon accessing the GERAN cell, the wireless communication device 104 may continue 514 with the voice call setup. This may include establishing a circuit switched (CS) connection between the wireless communication device 104 and the GERAN cell. During the voice call setup, the wireless communication device 104 may perform a location area update if the location area identity (LAI) of the selected GERAN cell is different than the location area identity (LAI) stored in the wireless communication device 104.

Upon establishing the circuit switched (CS) connection, the wireless communication device 104 may determine 516 if the GERAN cell supports general packet radio service (GPRS). For example, upon receiving 508 the system information type 3 (SI3) message 108, the wireless communication device 104 would know if general packet radio service (GPRS) is supported in the GERAN cell. If general packet radio service (GPRS) is supported, then the wireless communication device 104 may follow a general packet radio service (GPRS) suspension procedure at the start of a dedicated circuit switched (CS) connection. If general packet radio service (GPRS) is not supported by the GERAN cell, the general packet radio service (GPRS) suspension procedure may be omitted.

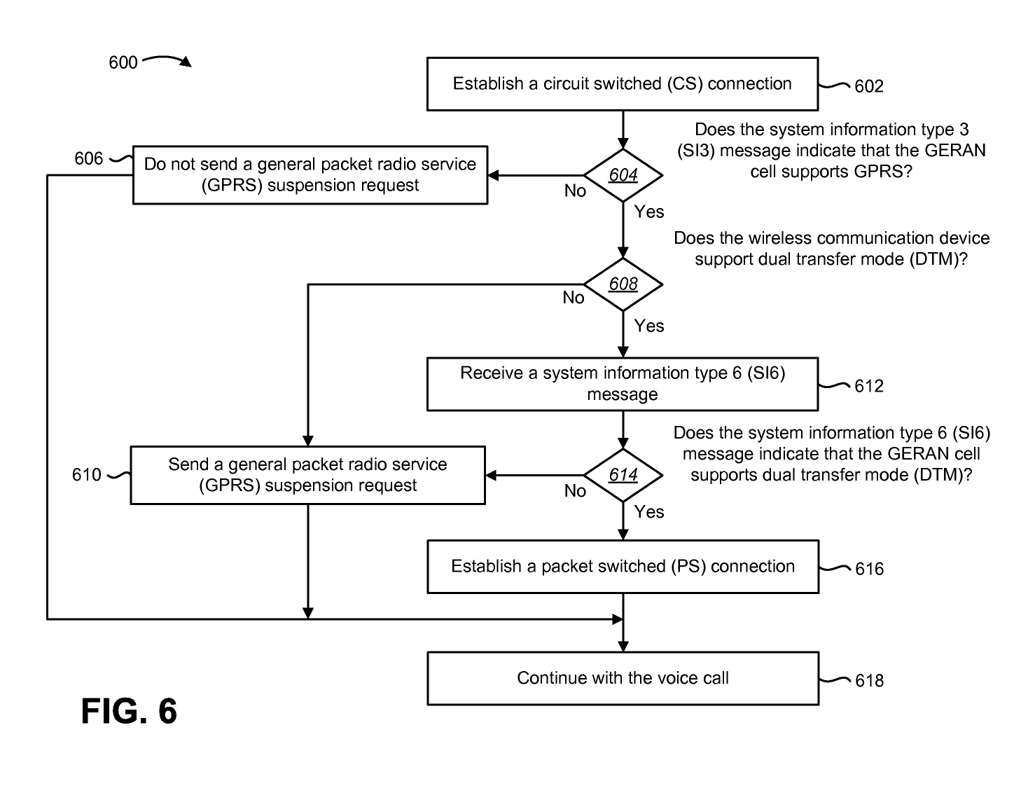

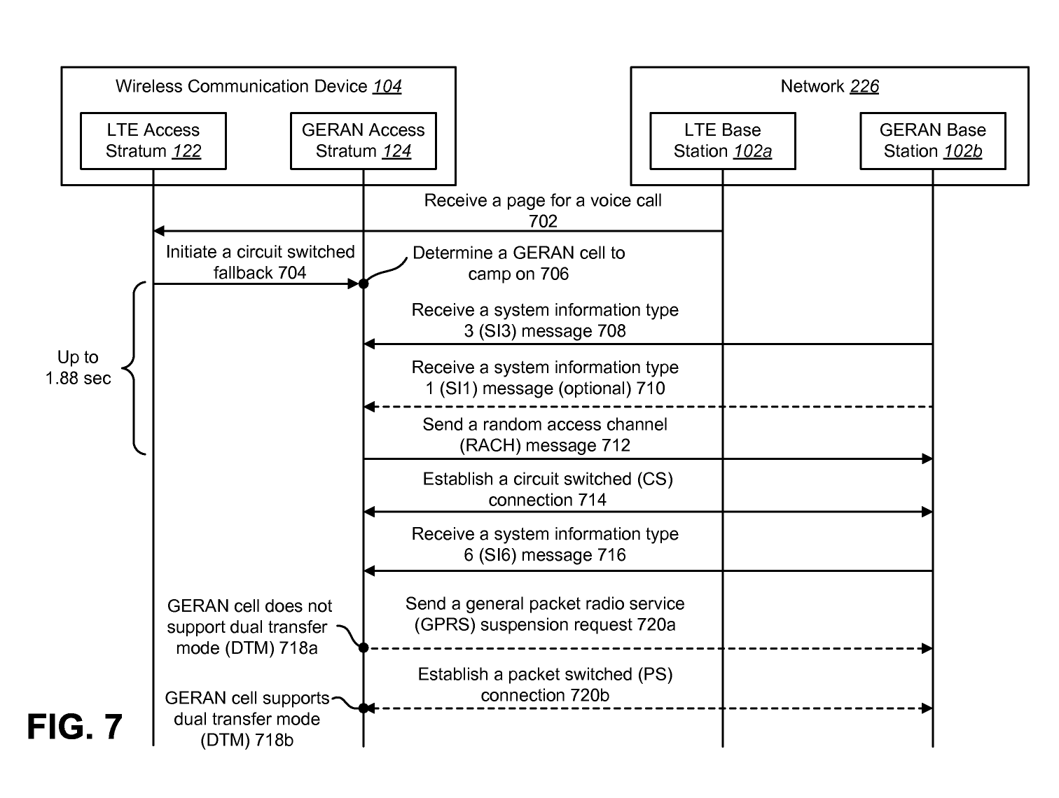

Therefore, if the GERAN cell supports general packet radio service (GPRS) but the wireless communication device 104 does not support dual transfer mode (DTM), then the wireless communication device 104 may send 518 a general packet radio service (GPRS) suspension request. However, if the GERAN cell does not support general packet radio service (GPRS), then the wireless communication device 104 may not send (e.g., omit sending) the general packet radio service (GPRS) suspension request. Various scenarios where the wireless communication device 104 supports dual transfer mode (DTM) and the GERAN cell supports general packet radio service (GPRS) are discussed below in connection with FIG. 6 and FIG. 7.

After the release of the voice call (e.g., release of the circuit switched (CS) connection), the wireless communication device 104 may acquire the system information type 13 (SI13) message 110 and perform general packet radio service (GPRS) related activities based on the system information type 13 (SI13) message 110. The described systems and methods may considerably cut down on the call setup time from more than several seconds to less than two seconds. This may result in a better user experience than what the current specification provides.

FIG. 6 is a flow diagram of a more detailed method 600 for performing a reduced latency circuit switched fallback (CSFB) procedure. The method 600 may be performed by a wireless communication device 104. In one configuration, the wireless communication device 104 may include a reduced latency circuit switched fallback (CSFB) module 112. The wireless communication device 104 may establish 602 a circuit switched (CS) connection on a GERAN cell as illustrated above in connection with FIG. 4. For example, the wireless communication device 104 may initiate a circuit switched fallback (CSFB) from an LTE cell to a GERAN cell in response to a page for a voice call. The wireless communication device 104 may receive a system information type 3 (SI3) message 108 from the GERAN base station 102b associated with the GERAN cell. The wireless communication device 104 may then access the GERAN cell based on the system information type 3 (SI3) message 108 without receiving a system information type 13 (SI13) message 110. The wireless communication device 104 may then establish 602 the circuit switched (CS) connection on the GERAN cell.

Upon establishing 602 the circuit switched (CS) connection, the wireless communication device 104 may determine 604 whether the system information type 3 (SI3) message 108 indicates that the GERAN cell supports general packet radio service (GPRS). If the GERAN cell does not support general packet radio service (GPRS), then the wireless communication device 104 does not send 606 a general packet radio service (GPRS) suspension request to the GERAN base station 102b. In this case, because the GERAN cell does not support general packet radio service (GPRS), dual transfer mode (DTM) is unavailable to the wireless communication device 104 (even if supported by the wireless communication device 104), and the general packet radio service (GPRS) suspension request does not need to be sent to the GERAN base station 102b. The wireless communication device 104 may continue 618 with the voice call setup.

If the wireless communication device 104 determines 604 that the GERAN cell supports general packet radio service (GPRS), then the wireless communication device 104 may determine 608 whether it supports dual transfer mode (DTM). If the wireless communication device 104 does not support dual transfer mode (DTM), then the wireless communication device 104 sends 610 a general packet radio service (GPRS) suspension request to the GERAN base station 102b.

However, if the wireless communication device 104 supports dual transfer mode (DTM), then the wireless communication device 104 may receive 612 a system information type 6 (SI6) message from the GERAN base station 102b. Once in a voice call, the wireless communication device 104 may find out through a system information type 6 (SI6) message sent on a slow associated control channel (SACCH). Therefore, even though the wireless communication device 104 does not know whether the GERAN cell supports dual transfer mode (DTM) at the time the wireless communication device 104 switches from LTE to GSM (e.g., the GERAN cell), once in the voice call, the wireless communication device 104 may determine 614 whether the GERAN cell supports dual transfer mode (DTM). If the system information type 6 (SI6) message indicates that the GERAN cell does not support dual transfer mode (DTM), then the wireless communication device 104 may send 610 a general packet radio service (GPRS) suspension request and continue 618 with the voice call setup.

If the system information type 6 (SI6) message indicates that the GERAN cell supports dual transfer mode (DTM), then the wireless communication device 104 may establish 616 a packet switched (PS) connection. For example, the wireless communication device 104 may perform a routing area update (RAU) for the general packet radio service (GPRS) operations. The wireless communication device 104 may then continue 618 with the voice call setup while operating as a dual transfer mode (DTM) device. In other words, upon establishing 616 the packet switched (PS) connection, the wireless communication device 104 may convert the voice call into a dual transfer mode (DTM) call. Therefore, the described systems and methods may improve voice call capabilities without disrupting data operations.

FIG. 7 is a thread diagram illustrating another embodiment of a reduced latency circuit switched fallback (CSFB) procedure. The wireless communication device 104 illustrated in FIG. 7 may be similar to the wireless communication device 104 described in connection with FIG. 1. The wireless communication device 104 may communicate with an LTE base station 102a and a GERAN base station 102b that are part of a network 226.

In one implementation, the wireless communication device 104 may communicate with the LTE base station 102a via an LTE access stratum (AS) 122. The wireless communication device 104 may communicate with the GERAN base station 102b via a GERAN access stratum (AS) 124. The wireless communication device 104 may initially be camped on an LTE cell associated with the LTE base station 102a. The LTE access stratum (AS) 122 may be in an idle state and the GERAN access stratum (AS) 124 may be in a NULL state. In the embodiment shown in FIG. 7, it is assumed that the wireless communication device 104 supports dual transfer mode (DTM) and the GERAN cell supports general packet radio service (GPRS).

The wireless communication device 104 may receive 702 a page for a voice call from the LTE base station 102a and may initiate 704 a circuit switched fallback (CSFB) from the LTE cell to a GERAN cell. The wireless communication device 104 may determine 706 the best GERAN cell to camp on and may receive system information (SI) broadcast from the GERAN base station 102b associated with that cell. The wireless communication device 104 may receive 708 a system information type 3 (SI3) message 108. The wireless communication device 104 may also receive 710 an optional system information type 1 (SI1) message. As described above, the wireless communication device 104 may acquire the system information type 3 (SI3) message 108 (and the optional system information type 1 (SI1) message) within 1.88 seconds from beginning to camp on the GERAN cell (step 706).

Upon receiving 708 the system information type 3 (SI3) message 108, the wireless communication device 104 may access the GERAN cell based on the system information type 3 (SI3) message 108 without receiving a system information type 13 message. For example, the wireless communication device 104 may send 712 a random access channel (RACH) message to the GERAN base station 102b to access the GERAN cell.

Upon accessing the GERAN cell, the wireless communication device 104 may establish 714 a circuit switched (CS) connection between the wireless communication device 104 and the GERAN cell. For example, during the voice call setup, the wireless communication device 104 may perform a location area update if the location area identity (LAI) of the selected GERAN cell is different than the location area identity (LAI) stored in the wireless communication device 104.

Upon establishing the circuit switched (CS) connection, the wireless communication device 104 may receive 716 a system information type 6 (SI6) message. The system information type 6 (SI6) message may be received 716 on a dedicated slow associated control channel (SACCH). The system information type 6 (SI6) message may indicate whether the GERAN cell supports dual transfer mode (DTM). If the wireless communication device 104 determines 718a that the GERAN cell does not support dual transfer mode (DTM), then the wireless communication device 104 may send 720a a general packet radio service (GPRS) suspension request to the GERAN base station 102b. The general packet radio service (GPRS) suspension request may instruct the packet switched (PS) domain to suspend (e.g., not perform) general packet radio service (GPRS) operations for the wireless communication device 104.

However, if the wireless communication device 104 determines 718b that the GERAN cell supports dual transfer mode (DTM), then the wireless communication device 104 may establish 720b a packet switched (PS) connection. The wireless communication device 104 may utilize dual transfer mode (DTM) procedures to perform a registration update in parallel with the voice call. For example, the wireless communication device 104 may perform a registration update (e.g., routing area update (RAU)) for the general packet radio service (GPRS) domain. The wireless communication device 104 may then start data transport and continue with the voice call. Therefore, upon establishing 720b the packet switched (PS) connection, the wireless communication device 104 may switch from a circuit switched (CS)-only mode to a circuit switched (CS) and packet switched (PS) mode.

According to some embodiments, the wireless communication device 104 may start a circuit switched fallback (CSFB) in an idle mode and enter (e.g., switch to) a dedicated mode without being aware of the dual transfer mode (DTM) capabilities of the GERAN cell. In other words, because the wireless communication device 104 does not read the system information type 13 (SI13) message 110, the wireless communication device 104 does not know whether the GERAN cell supports dual transfer mode (DTM) before entering a dedicated mode. Therefore, the wireless communication device 104 may switch from an idle mode to a dedicated mode without receiving a system information type 13 (SI13) message 110.

The wireless communication device 104 may determine the dual transfer mode (DTM) capabilities of the GERAN cell when the wireless communication device 104 goes into a dedicated call. For example, according to the described systems and methods, the wireless communication device 104 may initially assume that the GERAN cell does not support dual transfer mode (DTM). Upon establishing 714 the circuit switched (CS) connection (e.g., entering a dedicated mode), the wireless communication device 104 may receive 716 the system information type 6 (SI6) message, which indicates whether the GERAN cell supports dual transfer mode (DTM). Based on the system information type 6 (SI6) message, the wireless communication device 104 may then enter dual transfer mode (DTM).

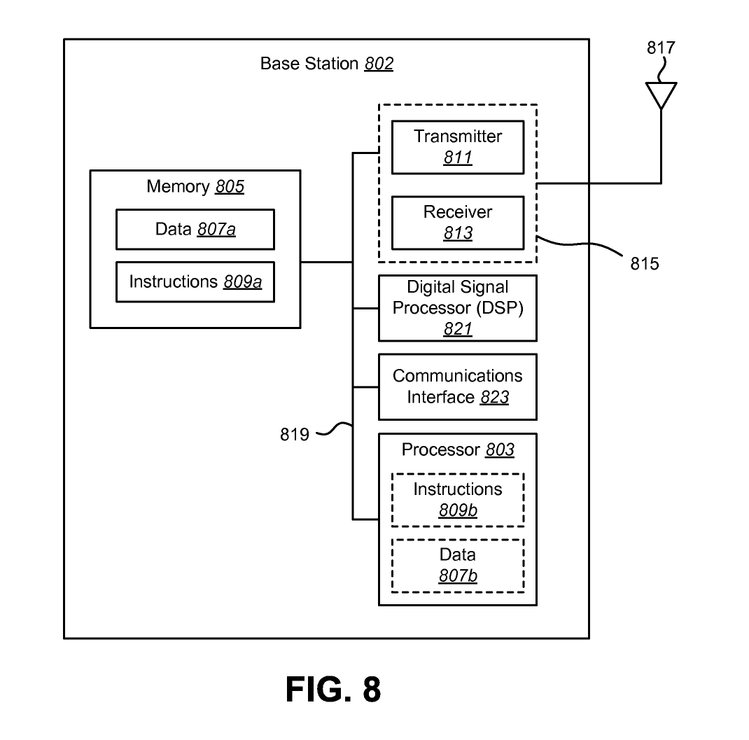

FIG. 8 illustrates certain components that may be included within a base station 802 according to some embodiments of the present invention. A base station 802 may also be referred to as, and may include some or all of the functionality of, an access point, a broadcast transmitter, a NodeB, an evolved NodeB, etc. For example, the base station 802 may be the LTE base station 102a or the GERAN base station 102b of FIG. 1.

The base station 802 includes a processor 803. The processor 803 may be a general purpose single- or multi-chip microprocessor (e.g., an ARM), a special purpose microprocessor (e.g., a digital signal processor (DSP)), a microcontroller, a programmable gate array, etc. The processor 803 may be referred to as a central processing unit (CPU). Although just a single processor 803 is shown in the base station 802 of FIG. 8, in an alternative configuration, a combination of processors (e.g., an ARM and DSP) could be used.

The base station 802 also includes memory 805. The memory 805 may be any electronic component capable of storing electronic information. The memory 805 may be embodied as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 807a and instructions 809a may be stored in the memory 805. The instructions 809a may be executable by the processor 803 to implement the methods disclosed herein. Executing the instructions 809a may involve the use of the data 807a that is stored in the memory 805. When the processor 803 executes the instructions 809a, various portions of the instructions 809b may be loaded onto the processor 803, and various pieces of data 807b may be loaded onto the processor 803.

The base station 802 may also include a transmitter 811 and a receiver 813 to allow transmission and reception of signals to and from the base station 802. The transmitter 811 and receiver 813 may be collectively referred to as a transceiver 815. An antenna 817 may be electrically coupled to the transceiver 815. The base station 802 may also include (not shown) multiple transmitters, multiple receivers, multiple transceivers and/or additional antennas.

The base station 802 may include a digital signal processor (DSP) 821. The base station 802 may also include a communications interface 823. The communications interface 823 may allow a user to interact with the base station 802.

The various components of the base station 802 may be coupled together by one or more buses, which may include a power bus, a control signal bus, a status signal bus, a data bus, etc. For the sake of clarity, the various buses are illustrated in FIG. 8 as a bus system 819.

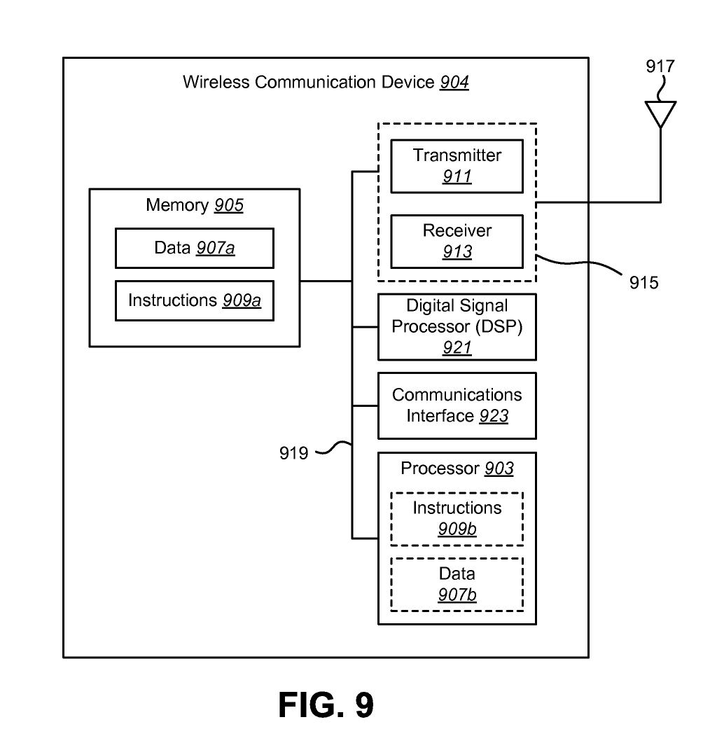

FIG. 9 illustrates certain components that may be included within a wireless communication device 904 according to some embodiments of the present invention. The wireless communication device 904 may be an access terminal, a mobile station, a user equipment (UE), etc. The wireless communication device 904 includes a processor 903. For example, the wireless communication device 904 may be the wireless communication device 104 of FIG. 1.

The processor 903 may be a general purpose single- or multi-chip microprocessor (e.g., an ARM), a special purpose microprocessor (e.g., a digital signal processor (DSP)), a microcontroller, a programmable gate array, etc. The processor 903 may be referred to as a central processing unit (CPU). Although just a single processor 903 is shown in the wireless communication device 904 of FIG. 9, in an alternative configuration, a combination of processors (e.g., an ARM and DSP) could be used.

The wireless communication device 904 also includes memory 905. The memory 905 may be any electronic component capable of storing electronic information. The memory 905 may be embodied as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 907a and instructions 909a may be stored in the memory 905. The instructions 909a may be executable by the processor 903 to implement the methods disclosed herein. Executing the instructions 909a may involve the use of the data 907a that is stored in the memory 905. When the processor 903 executes the instructions 909, various portions of the instructions 909b may be loaded onto the processor 903, and various pieces of data 907b may be loaded onto the processor 903.

The wireless communication device 904 may also include a transmitter 911 and a receiver 913 to allow transmission and reception of signals to and from the wireless communication device 904 via an antenna 917. The transmitter 911 and receiver 913 may be collectively referred to as a transceiver 915. The wireless communication device 904 may also include (not shown) multiple transmitters, multiple antennas, multiple receivers and/or multiple transceivers.

The wireless communication device 904 may include a digital signal processor (DSP) 921. The wireless communication device 904 may also include a communications interface 923. The communications interface 923 may allow a user to interact with the wireless communication device 904.

The various components of the wireless communication device 904 may be coupled together by one or more buses, which may include a power bus, a control signal bus, a status signal bus, a data bus, etc. For the sake of clarity, the various buses are illustrated in FIG. 9 as a bus system 919.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

In the above description, reference numbers have sometimes been used in connection with various terms. Where a term is used in connection with a reference number, this is meant to refer to a specific element that is shown in one or more of the Figures. Where a term is used without a reference number, this is meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIG. 4 and FIG. 6, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

We claim:

1. A method for wireless communication by a wireless communication device, the method comprising:
initiating a circuit switched fallback from an LTE cell to a GERAN cell;
receiving a system information type 3 message;
accessing the GERAN cell based on the system information type 3 message without receiving a system information type 13 message; and
establishing a circuit switched connection on the GERAN cell.

2. The method of claim 1, wherein accessing the GERAN cell comprises sending a random access channel message.

3. The method of claim 1, further comprising sending a general packet radio service suspension request if the wireless communication device does not support a dual transfer mode and the system information type 3 message indicates that the GERAN cell supports general packet radio service.

4. The method of claim 1, further comprising not sending a general packet radio service suspension request if the system information type 3 message indicates that the GERAN cell does not support general packet radio service.

5. The method of claim 1, further comprising receiving a system information type 6 message.

6. The method of claim 5, further comprising sending a general packet radio service suspension request if the system information type 6 message indicates that the GERAN cell does not support a dual transfer mode.

7. The method of claim 5, further comprising establishing a packet switched connection if the system information type 6 message indicates that the GERAN cell supports a dual transfer mode.

8. The method of claim 1, further comprising:
receiving a system information type 13 message after releasing the circuit switched connection; and
performing general packet radio service procedures based on the system information type 13 message.

9. The method of claim 1, wherein establishing the circuit switched connection comprises performing a location area update without performing a routing area update.

10. The method of claim 1, further comprising switching from an idle mode to a dedicated mode without receiving a system information type 13 message.

11. An apparatus for wireless communication, comprising:
a processor; a communications interface; memory in electronic communication with the processor; and
instructions stored in the memory, the instructions being executable by the processor to:
initiate a circuit switched fallback from an LTE cell to a GERAN cell via the communications interface;
receive a system information type 3 message via the communications interface;
access the GERAN cell, via the communications interface, based on the system information type 3 message without receiving a system information type 13 message; and
establish a circuit switched connection on the GERAN cell via the communications interface.

12. The apparatus of claim 11, wherein the instructions executable to access the GERAN cell comprise instructions executable to send a random access channel message.

13. The apparatus of claim 11, further comprising instructions executable to send a general packet radio service suspension request if the apparatus does not support a dual transfer mode and the system information type 3 message indicates that the GERAN cell supports general packet radio service.

14. The apparatus of claim 11, further comprising instructions executable to not send a general packet radio service suspension request if the system information type 3 message indicates that the GERAN cell does not support general packet radio service.

15. The apparatus of claim 11, further comprising instructions executable to receive a system information type 6 message.

16. The apparatus of claim 15, further comprising instructions executable to send a general packet radio service suspension request if the system information type 6 message indicates that the GERAN cell does not support a dual transfer mode.

17. The apparatus of claim 15, further comprising instructions executable to establish a packet switched connection if the system information type 6 message indicates that the GERAN cell supports a dual transfer mode.

18. The apparatus of claim 11, further comprising instructions executable to:
receive a system information type 13 message after releasing the circuit switched connection; and
perform general packet radio service procedures based on the system information type 13 message.

19. The apparatus of claim 11, wherein the instructions executable to establish the circuit switched connection comprise instructions executable to perform a location area update without performing a routing area update.

20. The apparatus of claim 11, further comprising instructions executable to switch from an idle mode to a dedicated mode without receiving a system information type 13 message.

21. A computer-program product for wireless communications, the computer-program product comprising a non-transitory computer-readable medium having instructions thereon, the instructions comprising:
code for causing a wireless communication device to initiate a circuit switched fallback from an LTE cell to a GERAN cell;
code for causing the wireless communication device to receive a system information type 3 message;
code for causing the wireless communication device to access the GERAN cell based on the system information type 3 message without receiving a system information type 13 message; and
code for causing the wireless communication device to establish a circuit switched connection on the GERAN cell.

22. The computer-program product of claim 21, wherein the code for causing the wireless communication device to access the GERAN cell comprises code for causing the wireless communication device to send a random access channel message.

23. The computer-program product of claim 21, further comprising code for causing the wireless communication device to send a general packet radio service suspension request if the wireless communication device does not support a dual transfer mode and the system information type 3 message indicates that the GERAN cell supports general packet radio service.

24. The computer-program product of claim 21, further comprising code for causing the wireless communication device to not send a general packet radio service suspension request if the system information type 3 message indicates that the GERAN cell does not support general packet radio service.

25. The computer-program product of claim 21, further comprising code for causing the wireless communication device to receive a system information type 6 message.

26. The computer-program product of claim 25, further comprising code for causing the wireless communication device to send a general packet radio service suspension request if the system information type 6 message indicates that the GERAN cell does not support a dual transfer mode.

27. The computer-program product of claim 25, further comprising code for causing the wireless communication device to establish a packet switched connection if the system information type 6 message indicates that the GERAN cell supports a dual transfer mode.

28. The computer-program product of claim 21, further comprising:
code for causing the wireless communication device to receive a system information type 13 message after releasing the circuit switched connection; and
code for causing the wireless communication device to perform general packet radio service procedures based on the system information type 13 message.

29. The computer-program product of claim 21, wherein the code for causing the wireless communication device to establish the circuit switched connection comprises code for causing the wireless communication device to perform a location area update without performing a routing area update.

30. The computer-program product of claim 21, further comprising code for causing the wireless communication device to switch from an idle mode to a dedicated mode without receiving a system information type 13 message.
